(19) United States
(12) Patent Application Publication
(10) Pub. No.: US 2024/0423228 A1
(43) Pub. Date: Dec. 26, 2024

(54) CHEESE ANALOGUE PRODUCT INCLUDING CORN PROTEIN ISOLATE

(71) Applicant: Cargill, Incorporated, Wayzata, MN (US)

(72) Inventors: Mercedes BRIGHENTI, Etterbeek (BE); Joachim CLERBAUX, Auderghem (BE)

(73) Assignee: Cargill, Incorporated, Wayzata, MN (US)

(21) Appl. No.: 18/706,438

(22) PCT Filed: Nov. 1, 2022
(86) PCT No.: PCT/US2022/079070

§ 371 Date: May 1, 2024

Related U.S. Application Data
(60) Provisional application No. 63/274,690, filed on Nov. 2, 2021.

(51) Int. Cl. A23C 20/02; A23J 3/14

(52) U.S. Cl. CPC A23C 20/02; A23J 3/14

(57) ABSTRACT

A cheese analogue product includes a corn protein isolate (CPI) that is ≥0.1 wt % to ≤20 wt % of the cheese analogue product. At least about 85 wt % of the CPI on a dry basis is corn protein. The CPI includes an “a*” color value ranging from about −2.5 to about 1.5 and a “b*” color value ranging from about 5 to about 25.

### CROSS-REFERENCE TO RELATED APPLICATION

This application claims the benefit of U.S. Provisional Patent Application No. 63/274,690, filed Nov. 2, 2021, which is incorporated by reference herein in its entirety.

### BACKGROUND

A cheese is a food composition including milk curd that has been separated from the whey. Examples of cheeses include Mozzarella cheese, asiago cheese, Romano cheese, provolone cheese, parmesan cheese, cheddar cheese, Colby cheese and Monterey jack cheese. A cheese analogue product is a food composition that has properties similar to cheese, but in which constituents including milk fat and/or protein have been partly or completely replaced by other ingredients. However, analogue cheeses including non-dairy protein sources can suffer from poor browning during baking, brittleness, poor processability, and/or unpalatable flavor. For example, protein derived from peas or potatoes can bring off-notes, and protein derived from wheat or soy can be an allergen. Most commercial block vegan cheeses are starch-based and have no protein or low protein levels (e.g., ˜3 wt %).

### SUMMARY OF THE INVENTION

The present invention provides a cheese analogue product. The cheese analogue product includes a corn protein isolate (CPI) that is ≥0.1 wt % to ≤20 wt % of the cheese analogue product. At least about 85 wt % of the CPI on a dry basis is corn protein. The CPI includes an “a*” color value ranging from about −2.5 to about 1.5, and a “b*” color value ranging from about 5 to about 25.

The present invention provides a vegan cheese product. The vegan cheese product includes a corn protein isolate (CPI) that is ≥0.1 wt % and ≤20 wt % of the vegan cheese product. The vegan cheese product includes one or more fats that are 5 wt % to 25 wt % of the vegan cheese product. The vegan cheese product includes one or more starch components that are 5 wt % to 25 wt % of the vegan cheese product. The vegan cheese product includes water that is 40 wt % to 60 wt % of the vegan cheese product. At least about 85 wt % of the CPI on a dry basis is corn protein. The CPI includes an “a*” color value ranging from about −2.5 to about 1.5, and a “b*” color value ranging from about 5 to about 25.

The present invention provides a method of making a cheese analogue product. The method includes heating a mixture of hydrated CPI and oil to form the cheese analogue product. The CPI is ≥0.1 wt % to ≤20 wt % of the cheese analogue product. At least about 85 wt % of the CPI on a dry basis is corn protein. The CPI includes an “a*” color value ranging from about −2.5 to about 1.5, and a “b*” color value ranging from about 5 to about 25.

The present invention provides a method of making a cheese analogue product. The method includes combining CPI with water to hydrate the CPI. The method includes combining dry ingredients with an oil. The method includes combining the hydrated CPI and the oil that includes the dry ingredients to form a mixture. The method includes heating the mixture of hydrated CPI and oil to 50° C. to 95° C. for at least about 1 minute, to form the cheese analogue product. The CPI is ≥0.1 wt % to ≤20 wt % of the cheese analogue product. At least about 85 wt % of the CPI on a dry basis is corn protein. The CPI includes an “a*” color value ranging from about −2.5 to about 1.5, and a “b*” color value ranging from about 5 to about 25.

In various aspects, the cheese analogue product of the present invention has advantageous features. For example, in various aspects, the cheese analogue product of the present invention can be a vegan cheese product containing substantially no milk protein allergens and can be suitable for consumption by individuals who are lactose-intolerant. In various aspects, the cheese analogue product of the present invention can have a more appealing color after baking, such as a browner color similar more similar to the oven-browning of conventional cheese, as compared to other cheese analogue products or vegan cheeses. In various aspects, the cheese analogue product of the present invention can have reduced brittleness as compared to other cheese analogue products (e.g., such as due to the CPI acting as an inert filler in the starch matrix, reducing its retrogradation), such as compared to other cheese analogue that do not include the CPI of the present invention. In various aspects, the cheese analogue product of the present invention can have a neutral or bland flavor that allows facile addition of flavoring agents without a need for masking agents to improve palatability. In various aspects, the cheese analogue product of the present invention can have less fat but can still retain a similar texture, as compared to other cheese analogue products or vegan cheeses.

In various aspects, the CPI used in the cheese analogue product of the present invention can have a blander flavor as compared to other protein sources, such as compared to potato, pea, or wheat protein sources. In various aspects, the CPI used in the cheese analogue product of the present invention can have low color as compared to pea and wheat protein sources. The CPI used in the cheese analogue product of the present invention can have less allergens as compared to other protein sources, such as compared to soy, wheat, and dairy protein sources.

In various aspects, the cheese analogue product of the present invention can have higher protein content than other cheese analogue products, such as compared to other vegan cheeses (the majority of which include no protein or less than or equal to 5 wt % protein). For example, due to the bland flavor of the CPI, the cheese analogue product of the present invention can incorporate a higher protein content than other cheese analogue products without a need for masking agents to mask the protein taste. Although cashew-based cheese analogue products can have up to 19% protein, these products are not suitable or intended for baking. The higher protein content of the cheese analogue product of the present invention can give the cheese analogue product an improved nutritional profile as compared to other cheese analogue products, such as compared to other vegan cheeses.

In various aspects, the cheese analogue product of the present invention including CPI can have improved nutrition and/or improved browning when baked, compared to cheese analogue products with no protein added. In various aspects, the cheese analogue product of the present invention including CPI can have a blander flavor than cheese analogue products made from other vegetable proteins such as pea, lentil, rice, faba, soy, potato, and oat. In various aspects, the cheese analogue product of the present invention including CPI can have improved color, improved flavor, and/or lower development of hardness over time compared to cheese analogue products made from other vegetable proteins such as potato, pea, faba, and oat. In various aspects, the cheese analogue product of the present invention including CPI can have less or no allergen than cheese analog products made from other vegetable proteins such as soy or wheat.

### BRIEF DESCRIPTION OF THE FIGURES

The drawings illustrate generally, by way of example, but not by way of limitation, various aspects of the present invention.

FIG. 1A illustrates a photograph of a commercial conventional vegan cheese that did not include CPI.

FIG. 1B illustrates a photograph of a vegan cheese including no CPI.

FIGS. 1C-E illustrates photographs of various vegan cheeses including CPI, in accordance with various aspects.

FIG. 2A illustrates a photograph of a grater after grating a commercial conventional vegan cheese that did not include CPI.

FIGS. 2B-E illustrates photographs of a grater after grating various vegan cheeses including CPI, in accordance with various aspects.

FIG. 3A illustrates a photograph of a vegan cheese including no CPI after toasting in an oven.

FIGS. 3B-C illustrate photographs of various vegan cheeses including CPI, in accordance with various aspects.

FIG. 4 illustrates a photograph of a reference card of mozzarella cheese baked at 230° C. for various time periods, in accordance with various aspects.

FIG. 5 illustrates a photograph of a reference card showing scores of 1-5 for residue on grater for PBAC prototypes, in accordance with various aspects.

FIG. 6 illustrates a schematic of force versus time of deformation for a two-bite texture profile analysis, in accordance with various aspects.

FIG. 7 illustrates a photograph showing color of various PBAC prototypes at 14 days, with a NO-Protein prototype (left) and a CPI prototype (right), in accordance with various aspects.

FIG. 8 illustrates a photograph showing color of PBAC samples after baking at 14 days, with a NO-protein sample (left) and a CPI sample (right), in accordance with various aspects.

FIG. 9 illustrates results of residue on grater of NO-Protein samples compared to CPI samples, in accordance with various aspects.

FIG. 10 illustrates development of hardness over time as determined by TPA in NO-Protein PBAC and CPI PBAC, in accordance with various aspects.

FIG. 11 illustrates cohesiveness of NO-Protein PBAC compared to CPI PBAC at 14 days, in accordance with various aspects.

FIG. 12 illustrates photographs of PBACs made with proteins from various vegetable sources at day 14, in accordance with various aspects.

FIG. 13 illustrates photographs of PBACs made with proteins from various vegetable sources after baking at day 14, in accordance with various aspects.

FIG. 14 illustrates a performance map of CPI-containing PBAC compared to mozzarella, PBAC with no protein, and PBAC with other vegetable proteins, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material.

The term “cheese analogue product” as used herein is a food composition that has properties similar to cheese, but in which constituents including milk fat and/or protein have been partly or completely replaced by other ingredients. Analogue cheese may be categorized, based on its source of fats and proteins, as “partial dairy” or “non-dairy”. If some fats and/or proteins come from dairy sources, while others have been replaced with non-dairy fats and/or proteins, these can be referred to as partial dairy whereas if all fats and proteins come from non-dairy sources, these can be referred to as “non-dairy”. “Non-dairy” analogue cheese can be consumed by individuals who are lactose-intolerant and who have allergies to milk protein. Compared to cheese, analogue cheese may be preferred nutritionally (e.g., based on fatty acid profiles), and may be equal nutritionally or may be less preferred nutritionally in some cases. An analogue cheese may be used as a replacement for cheese in food products. One variant of analogue cheese may be designed to melt well on pizza, while also remaining chewy. An analogue cheese may be formulated for processing with basic cheese-making equipment and processing techniques that Mozzarella cheese requires, such as, for example, the processes of mixing and molding, or with cheese-making equipment used for making processed cheese.

The term “starch” as used herein refers to a carbohydrate polymer such as amylose and/or amylopectin that can be derived from a suitable native or modified plant species. Typical sources for starches are cereals, tubers, roots, legumes and fruits. Native sources can be corn, pea, potato, sweet potato, banana, barley, wheat, rice, sago, amaranth, tapioca, arrowroot, canna, sorghum, and waxy or high amylose varieties thereof. As used herein, the term “waxy” is intended to include a starch or flour containing at least about 95% by weight amylopectin and the term “high amylose” is intended to include a starch or flour containing at least about 40% by weight amylose. Starches can be derived from a plant obtained by standard breeding techniques including crossbreeding, translocation, inversion, transformation or any other method of gene or chromosome engineering to include variations thereof. Additionally, starches derived from plants grown from artificial mutations and variations of the above generic composition which may be produced by known standard methods of mutation breeding are also suitable herein.

The following applications are incorporated by reference herein: WO2016154441, WO2019028263, WO2017165748, WO2017165756, WO 2018237030, WO2019060673, and WO2020092964.

### Cheese Analogue Product.

The present invention provides a cheese analogue product. The cheese analogue product includes a corn protein isolate that is ≥0.1 wt % to ≤20 wt % of the cheese analogue product. At least about 85 wt % of the CPI on a dry basis is corn protein. The CPI includes an “a*” color value ranging from about −2.5 to about 1.5, and a “b*” color value ranging from about 5 to about 25.

The cheese analogue product can be substantially free of materials derived from animal sources. For example, less than 1 wt % of the cheese analogue product, or about 0 wt % of the cheese analogue product, can be one or more materials derived from animal sources. The cheese analogue product can be substantially free of protein and fat from animal sources. For example, less than 1 wt % of the cheese analogue product, or about 0 wt % of the cheese analogue product, can be one or more proteins or fats derived from animal sources. The cheese analogue product can be substantially free of materials derived from dairy sources. For example, less than 1 wt % of the cheese analogue product, or about 0 wt % of the cheese analogue product, can be one or more materials derived from dairy sources. The cheese analogue product can be a vegan cheese. The cheese analogue product can be a block vegan cheese. In various aspects, the cheese analogue product can include one or more materials derived from animal sources, such as dairy sources; for example, the one or more materials derived from animal sources can be fats or proteins that can form a major or minor proportion of the fats and/or proteins in the cheese analogue product.

The CPI can form any suitable proportion of the cheese analogue product. For example, the CPI can be ≥0.1 wt % to ≤20 wt % of the cheese analogue product, ≥1 wt % to ≤10 wt %, ≥3 wt % to ≤9 wt %, ≥5 wt % to ≤7 wt %, or less than or equal to 20 wt % and greater than or equal to 0.1 wt %, 0.2, 0.4, 0.6, 0.8, 1, 1.2, 1.4, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, or 19.5 wt %. In aspects of the cheese analogue including one or more fats, the weight ratio of the one or more fats to the CPI can be 1:1 to 4:1, 1.5:1 to 3.5:1, 3.1:1 to 3.5:1, or less than or equal to 4:1 and greater than or equal to 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, 3.5:1, 3.6:1, 3.7:1, 3.8:1, or 3.9:1. In aspects of the cheese analogue including one or more starch components, a weight ratio of the one or more starch components to the CPI is 1:1 to 4:1, 1.3:1 to 3.2:1, 2.5:1 to 3.5:1, or less than or equal to 4:1 and greater than or equal to 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, 3.5:1, 3.6:1, 3.7:1, 3.8:1, or 3.9:1.

The CPI can be less than about 1.5 wt % oil on a dry basis (e.g., not including the one or more fats added to the CPI to form the cheese analogue product, such as as measured prior to combination of the CPI with the oil in the cheese analogue product), less than 1 wt % oil on a dry basis, or less than about 0.5 wt % oil on a dry basis, or less than about 1.5 wt %, 1.4, 1.3, 1.2, 1.1, 1, 0.9, 0.8, 0.7, 0.6, 0.5, 0.4, 0.3, or less than about 0.2 wt % oil on a dry basis.

Corn protein can be any suitable proportion of the CPI, such as 85 wt % of the CPI or more on a dry basis, or about 87 wt % to about 98 wt % of the CPI on a dry basis, or about 87 wt % to about 92 wt % of the CPI on a dry basis, or less than or equal to about 98 wt % and greater than or equal to about 85 wt %, 86, 87, 88, 89, 90, 91, 92, 93, 94, 95, 96, or 97 wt % on a dry basis. The CPI can include a mixture of two or more or of all of the different types of protein in the corn from which the isolate was formed. The CPI can include one or more corn prolamin proteins, one or more corn glutelin proteins, or a combination thereof. The CPI can have a ratio of a weight of corn prolamin proteins to a weight of corn glutelin proteins of 0.1:1-10:1, or 0.2:1-5:1, or 0.5: to 2:1, or less than or equal to 10:1 and greater than or equal to 0.1:1, 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.5:1, 3:1, 4:1, 5:1, 6:1, 7:1, 8:1, or 9:1. The CPI can include gliadin, hordein, secalin, zein, kafirin, avenin, or a combination thereof. The CPI can include one or more non-zein proteins. The CPI can include one or more non-prolamin proteins. The CPI can include one or more proteins in addition to zein, or in addition to one or more prolamin proteins.

The CPI can have any suitable L* color value. For example, the CPI can have an L* color value of at least 88, or of about 88 to about 95, or from about 90 to about 92, or less than or equal to 95 and greater than or equal to about 88, 89, 90, 91, 92, 93, or 94. The CPI can have any suitable “a*” color value, such as an a* color value of about −2.5 to about 1.5, −2.5 to −0.5, −2 to −1, −0.3 to 0.3, −0.2 to 0.2, or less than or equal to about 1.5 and greater than or equal to about −2.5, −2.4, −2.3, −2.2, −2.1, −2, −1.9, −1.8, −1.7, −1.6, −1.5, −1.4, −1.3, −1.2, −1.1, −1, −0.9, −0.8, −0.7, −0.6, −0.5, −0.4, −0.3, −0.2, −0.1, 0, 0.1, 0.2, 0.3, 0.4, 0.5, 0.6, 0.7, 0.8, 0.9, 1, 1.1, 1.2, 1.3, or 1.4. The CPI can have any suitable “b*” color value, such as about 5 to about 25, about 1.0 to about 20, from about 10 to about 15, or less than or equal to 25 and greater than or equal to 5, 6, 7, 8, 9, 10, 11, 12, 13, 14, 15, 16, 17, 18, 19, 20, 21, 22, 23, or 24. The L* value, “a*” value, and “b*” value can be measured using a colorimeter, such as described in the present Working Examples.

The CPI can have any suitable soluble carbohydrate concentration, such as a soluble carbohydrate concentration of 40 g/kg or less, or 25 g/kg or less, or equal to or less than about 40 g/kg, 38, 36, 34, 32, 30, 28, 26, 24, 22, 20, 18, 16, 14, 12, or 10 g/kg or less.

The CPI can have any suitable organic acid concentration, such as an organic acid concentration of about 4.25 g/kg or less, 3.5 g/kg or less, or 2.0 g/kg or less, or less than or equal to 4.25 g/kg, 4.2 4.1, 3, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, or 1 g/kg or less.

The CPI can have an aflatoxin concentration of less than about 1 ppb, or less than about 0.5 ppb, or no detectable aflatoxin. AOAC 994.08 can be used to test for aflatoxin.

The CPI can have a free sulfite concentration of less than about 150 ppm, less than about 120 ppm, or less than about 100 ppm, or no detectable free sulfite concentration. Free sulfite can be measured by the Monier-Williams AOAC 990.28 method.

The CPI can have any suitable particle size. For example, the CPI can have a D95 particle size of 5 microns to 40 microns, or 10 microns to 30 microns, or 15 microns to 25 microns, or less than or equal to 40 microns and greater than or equal to 5 microns, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, or 39 microns. The CPI can have a D50 particle size of 1 micron to 30 microns, or 2 microns to 15 microns, or 5 microns to 10 microns, or less than or equal to 30 microns and greater than or equal to 1 micron, 2, 3, 4, 5, 6, 7, 8, 9, 10, 11, 12, 13, 14, 15, 16, 17, 18, 19, 20, 21, 22, 23, 24, 25, 26, 27, 28, or 29 microns.

The CPI can be formed via any suitable process that forms a suitable CPI for the cheese analogue product of the present invention described herein. For example, the CPI can be formed using a method including providing a destarched corn gluten material, and washing the destarched corn gluten material with a solvent including water and a water-miscible organic solvent to obtain the CPI. The destarched corn gluten material can include residual insoluble starch solids ranging from about 0.1 to about 3.0 wt % on a dry basis, as measured by Ewers' Polarimetric method ISO 10520:1997. The water-miscible organic solvent can include ethanol, isopropanol, or mixtures thereof, in a concentration ranging from about 75 wt % to about 100 wt %. The water-miscible organic solvent can be in a concentration ranging from about 85 wt % to about 100 wt %, from about 75 wt % to about 95 wt %, or from about 85 wt % to about 95 wt %. The volume of the water-miscible organic solvent can be from about 3 to about 40 liters per kilogram of destarched corn gluten having a moisture content of up to 65 wt %.

The CPI can be made using a method including providing a corn gluten material including at least about 65 wt % protein, destarching the corn gluten material, and washing the destarched corn gluten material with a solvent including about 75 wt % to about 100 wt % ethanol or isopropanol to remove non-protein components, to obtain the CPI. The non-protein components can include organic acids, carbohydrates, mycotoxins, and oils. The CPI can be made using a method including providing a destarched corn gluten material and washing the destarched corn gluten material with a solvent including water and a water-miscible organic solvent to obtain the CPI, wherein a total of from about 3 L to about 40 L of solvent per kilogram of destarched corn gluten material is used during the washing step. The solvent can be chosen from ethanol, ethyl acetate, isopropanol, and mixtures thereof. In some aspects, the corn gluten material can be the corn protein concentrate described in U.S. Pat. No. 9,226,515, hereby incorporated by reference in its entirety.

The cheese analogue product can include one or more fats. The one or more fats can form any suitable proportion of the cheese analogue product, such as 1 wt % to 35 wt % of the cheese analogue product, 1 wt % to 30 wt %, 5 wt % to 25 wt %, 15 wt % to 25 wt %, or less than or equal to 30 wt % and greater than or equal to 1 wt %, 2, 4, 6, 8, 10, 11, 12, 13, 14, 15, 16, 17, 18, 19, 20, 21, 22, 23, 24, 25, 26, 27, 28, 29, 30, 31, 32, 33, or 34 wt % of the cheese analogue product. The one or more fats can be any suitable fats or oils. For example, the one or more fats can include an animal-based oil, a plant-based oil, or a combination thereof. The one or more fats can include coconut oil, corn oil, canola oil, cottonseed oil, olive oil, palm oil, peanut oil, rapeseed oil, safflower oil, sesame oil, soybean oil, sunflower oil, cocoa butter, shea butter, mango butter, a fraction thereof, a middle or high oleic version thereof, a hydrogenated oil formed therefrom, an interesterified oil formed therefrom, or a combination thereof. The one or more fats can include a hydrogenated coconut oil.

The cheese analogue product can include one or more starch components. A starch is a carbohydrate polymer. Starches include amylose and/or amylopectin and are typically in the form of granules. Amylopectin is the major component (about 70-80%) of most starches. It is found in the outer portion of starch granules and is a branched polymer of several thousand to several hundred thousand glucose units. Amylose is the minor component (about 20-30%) of most starches. However, there are high amylose starches with 50-70% amylose. Amylose is found in the inner portion of starch granules and is a linear glucose polymer of several hundred to several thousand glucose units. Some starches are classified as waxy starches. A waxy starch consists essentially of amylopectin. Common waxy starches include waxy maize starch, waxy corn starch, and waxy wheat starch. A modified starch has a structure that has been altered from its native state, resulting in modification of one or more of its chemical or physical properties. Starches may be modified, for example, by enzymes, oxidation or, substitution with various compounds. For example, starches can be modified to increase stability against heat, acids, or freezing, improve texture, increase or decrease viscosity, increase or decrease gelatinization times, and/or increase or decrease solubility, among others. Modified starches may be partially or completely degraded into shorter chains or glucose molecules. Amylopectin may be debranched. In one example, modified starches are cross-linked for example to improve stability. Starches that are modified by substitution have a different chemical composition.

The one or more starch components can form any suitable proportion of the cheese analogue product, such as 1 wt % to 40 wt % of the cheese analogue product, 1 wt % to 35 wt %, 1 wt % to 30 wt %, 5 wt % to 25 wt %, 15 wt % to 20 wt %, or less than or equal to 30 wt % and greater than or equal to 1 wt %, 2, 4, 6, 8, 10, 11, 12, 13, 14, 15, 16, 17, 18, 19, 20, 21, 22, 23, 24, 25, 26, 27, 28, 29, 30, 31, 32, 33, 34, 35, 36, 37, 38, or 39 wt % of the cheese analogue product. In aspects of the cheese analogue product including one or more fats, a weight ratio of the one or more fats to the one or more starch components can be 0.5:1 to 2:1, or 1:1 to 1.2:1, or less than or equal to 2:1 and greater than or equal to 0.5:1, 0.55:1, 0.6:1, 0.65:1, 0.7:1, 0.75:1, 0.8:1, 0.85:1, 0.9:1, 0.95:1, 1:1, 1.05:1, 1.1:1, 1.15:1, 1.2:1, 1.25:1, 1.3:1, 1.35:1, 1.4:1, 1.45:1, 1.5:1, 1.55:1, 1.6:1, 1.65:1, 1.7:1, 1.75:1, 1.8:1, 1.85:1, 1.9:1, or 1.95:1. The one or more starch components include one or more starches, modified starches, or a combination thereof. The one or more starches can be any suitable proportion of the one or more starch components, such as 50 wt % to 100 wt % of the one or more starch components, 90 wt % to 100 wt %, or greater than or equal to 50 wt %, 55, 60, 65, 70, 75, 80, 85, 90, 92, 94, 96, 98, or 99 wt % of the one or more starch components. The one or more starches in the one or more starch components can be one or more modified starches, one or more natural starches, or a combination thereof wherein the proportion of native starch to modified starch in the one or more starch components can be 10:1 to 0.1:1, or 5:1 to 0.2:1, or less than or equal to 10:1 and greater than or equal to 0.1:1, 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1. The one or more starches and/or modified starches can be derived from any suitable source, such as corn, pea, potato, sweet potato, banana, barley, wheat, rice, sago, amaranth, tapioca, arrowroot, canna, sorghum, buckwheat, barley, cassava, kudzu, oca, sago, taro, yam, bean, waxy or high amylose varieties thereof, or a combination thereof. In addition to the one or more starches and/or modified starches, the one or more starch components can include guar, carrageenan, or a combination thereof. In addition to the one or more starches and/or modified starches, the one or more starch components can include guar and carrageenan. The guar, carrageenan, or the combination thereof, can form any suitable proportion of the one or more starch components, such as 0.1 wt % to 30 wt %, 1 wt % to 10 wt %, or about 0 wt %, or less than or equal to 30 wt % and greater than or equal to 0.1 wt %, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, or 29 wt %

The cheese analogue product can be substantially free of added colorants (e.g., food colorings). For example, added colorants can be less than 0.1 wt % of the cheese analogue product. The cheese analogue product can include one or more colorants. The colorants can be any suitable colorants that produce an appealing color for a cheese, such as beta-carotene, annatto, carrot concentrate, apple concentrate, capsanthin, paprika extract, or a combination thereof.

The cheese analogue product can include a salt that is NaCl. The salt can form any suitable proportion of the cheese analogue product, such as 0 wt % to 5 wt % of the cheese analogue product, or 0.1 wt % to 3 wt %, or less than or equal to 5 wt % and greater than or equal to 0 wt %, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.2, 3.4, 3.6, 3.8, 4, 4.2, 4.4, 4.6, or 4.8 wt %.

The cheese analogue product can include water. The water can form any suitable proportion of the cheese analogue product, such as 30 wt % to 70 wt % of the cheese analogue product, 40 wt % to 60 wt %, 53 wt % to 58 wt %, or less than or equal to 70 wt % and greater than or equal to 30 wt %, 35, 40, 42, 44, 46, 48, 50, 51, 52, 53, 54, 55, 56, 57, 58, 59, 60, 62, 64, 66, or 68 wt % of the cheese analogue product.

The cheese analogue product can include one or more suitable additional ingredients. For example, the cheese analogue product can include one or more additives including fiber (e.g., soluble or insoluble dietary fiber), yeast, stabilizer, emulsifier, flavor, spices, flavor-masking agent, preservative, nutritional additive, texture-modification additive, or a combination thereof. Spices can contribute to appearance, taste, or a combination thereof. Examples of spices can include any suitable spice, such as tomatoes, chives, basil, onions, garlic, oregano, parsley, thyme, chili, pepper, paprika, or a combination thereof.

### Method of Making a Cheese Analogue Product.

The present invention provides a method of making a cheese analogue product. The method can be any suitable method that produces the cheese analogue product of the present invention described herein. The method can include heating a mixture of hydrated CPI and oil to form the cheese analogue product. The mixture of hydrated CPI and oil can be an emulsion. The method can optionally include cooling the cheese analogue product, such as to room temperature or to refrigeration temperatures.

The heating of the mixture of hydrated CPI and oil can include maintaining the mixture at 50° C. to 95° C. for at least about 1 minute, or at 75° to 90° C. for 2 minutes to 5 minutes, or at 80° to 85° C. for 2 minutes to 4 minutes. The method can further include combining the hydrated CPI and the oil. The method can include hydrating the CPI. Hydrating the CPI can include combining the CPI with water.

The oil further includes one or more starch components, and can optionally include one or more other components. The method can further include combining the one or more starch components (and one or more other optional components) with the oil prior to forming the mixture of the hydrated CPI and the oil. The method can further include heating the mixture of the hydrated CPI and oil to about 50° C. to about 95° C. prior to forming the mixture of the hydrated CPI and the oil, or to about 60° C. to about 70° C.

### EXAMPLES

Various aspects of the present invention can be better understood by reference to the following Examples which are offered by way of illustration. The present invention is not limited to the Examples given herein.

### Example 1. Corn Protein Isolate (CPI) Production

The CPI was form using a process including (1) destarching of corn gluten whereby specific pH conditions and calcium levels are used during the removal of the starch to improve or maximize mycotoxin losses, (2) washing with hydrogen peroxide to reduce sulfite levels, (3) washing with ethanol to remove fat, color and fat soluble mycotoxins and (4) desolventization to obtain a dry powder.

The starting material was a heavy corn gluten slurry that was an intermediate process stream in a corn wet milling process. In a normal corn wet milling process, this slurry is further mechanically dewatered by filtration and dried to obtain corn gluten meal.

Destarching and hydrogen peroxide wash. Heavy corn gluten slurry (10-13% dry substance) was sampled from a corn wet milling plant that is processing dent corn. The pH of the slurry was adjusted to 5.5 with caustic and amylase (Liquozyme Supra 2.2× from Novozymes) was added (1 g amylase per kg dry substance of slurry). Subsequently, the slurry was incubated during 4 hours at 85° C. under continuous stirring. After incubation, the slurry was cooled to 60° C., calcium chloride (2.5 g/kg slurry) was added and pH was adjusted with caustic to 6.8. After these adjustments, the slurry was filtered on a filter press (Choquenet) equipped with a 25 μm filter cloth (Sefar 6068-0018-542) to yield a cake and a filtrate. The filtrate was discarded. The cake while still being held in the filter press, was washed with 0.33% (w/w) hydrogen peroxide solution in water by circulation of the hydrogen peroxide solution over the cake during 60 minutes (about 2 kg hydrogen peroxide solution per kg of cake). After washing, the cake was compressed in the filter press and then released from the filter press to obtain destarched corn gluten cake at about 45% dry substance. Destarched corn gluten cake was frozen at −20° C. until further processing.

Ethanol wash, desolventization & milling. Frozen destarched corn gluten cake was thawed to about 0 to 1° C. and ground to obtain a fine powder (100%<3 mm) with an Urschel grinder (crushing head 3A050080U). The ground destarched corn gluten was then washed three times with 96% (v/v) potable ethanol. For each ethanol wash step, (1) 10 kg 96% (v/v) ethanol was added per kg dry substance of corn gluten cake, (2) the mixture was stirred for 30 minutes at ambient temperature in a bottom filter vessel, (3) the liquid was drained from the solids by applying a vacuum over a filter cloth (Tetex 03-125-430 W from Buisine) in the bottom filter vessel (liquid was discarded) and (4) the washed cake was broken up for the next washing step. After the third washing step, the washed cake was desolventized in the bottom filter vessel at 60° C. and under vacuum until a dry substance was reached of above 92%. Finally, the dried corn protein isolate was first hammer milled to break large chunks in the powder and subsequently micronized to below 30 μm using a 100-AFG mill from Hosokawa.

The CPI had a dry substance wt % of 92.8%, a protein wt % (protein calculated as nitrogen×6.25, after acid hydrolysis, on a dry basis) of 89.1%, a free fat wt % on a dry basis of <0.4%, a total fat wt % on a dry basis of <0.6%, an ash wt % on a dry basis of 3.9%, an ethanol wt % of 4.2%, and sulfite content of 70 ppm. The CPI had an L* value of 91.2, an a* value of −1.5, and a b* value of 13.0, as measured using a HunterLab Colorimeter (Model CFE2, Hunter Associates Laboratory, Inc., Reston, VA). All colorimeter measurements were made on dry powders. The instrument reads on in the Hunter L*, “a*”, and “b*” scale where the L* value is an indication of color lightness (the higher the value, the lighter/whiter the product). Hunter “a*” represents the red-green color spectrum with a positive value indicating a red hue. Hunter “b*” represents the yellow-blue spectrum with a positive value indicating a yellow hue. The D95 of the CPI was 22 microns, and the D50 was 7 microns, as determined using a laser diffraction Sympatec Helos BF.

### Example 2. Production of Vegan Cheese

Several vegan cheese samples were made using the corn protein isolate (CPI) produced in Example 1. The ingredients for the cheese samples is shown in Table 1. Amounts given are in weight percentage. Lygomme™ ACH 864 K is available from Cargill Inc. and is a combination of native starch, modified starch, guar, and carrageenan. The hydrogenated coconut fat was fully refined fully hydrogenated coconut oil 32 available from Cargill Inc and had a melting point of 30-34° C. Samples 1 and 2 were comparative.

TABLE 1
Cheese sample ingredients.

| Sample | 1 | 2 | 5 | 8 | 9 | 10 | 13 | 11 | 12 |
|---|---|---|---|---|---|---|---|---|---|
| Hydrogenated | 22 | 22 | 20 | 18 | 13 | 8 | 20 | 20 | 20 |
| coconut fat | | | | | | | | | |
| Lygomme ™ | 23 | 23 | 18 | 16 | 11 | 6 | 18 | 18 | 18 |
| ACH 864K | | | | | | | | | |
| CPI | 0 | 0 | 6 | 10 | 20 | 30 | 6 | 10 | 20 |
| Beta carotene | 0 | 0 | 0 | 0 | 0 | 0 | 0 | 0 | 0 |
| Salt | 0 | 0 | 0 | 1 | 1 | 1 | 0 | 1 | 1 |
| Water | 55 | 55 | 56 | 55 | 55 | 55 | 56 | 51 | 41 |
| pH | N | Y | N | N | N | N | N | N | N |
| adjustment to | | | | | | | | | |
| 4.3? | | | | | | | | | |

To make the cheese samples, water was placed into a steel bucket that included a stirrer. The water was heated to 40-45° C. and maintained at this temperature. The corn protein isolate (CPI) produced in Example 1 was added to the water. The CPI was allowed to hydrate in the warm water with stirring for 5 minutes. In a second steel bucket, the dry ingredients were mixed with oil at 65° C. under stirring for 5 minutes, which was adequate time to form a homogeneous mixture. The oil mixed with the dry ingredients and the water including the hydrated CPI were combined in a Stephan cooking mixer. For Sample 2, pH adjustment to 4.3 was performed; for the other Samples, no pH adjustment was performed. The mixture was heated to 82° C. with stirring and was maintained at this temperature for 3 minutes. The heated mixture was then cooled using an ice water bath. Once room temperature was reached, the product was stored in a refrigerator.

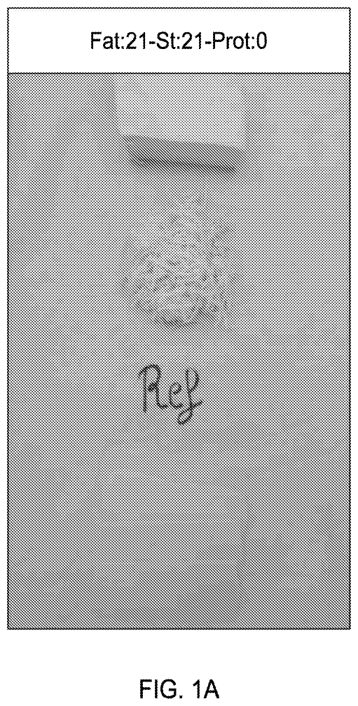

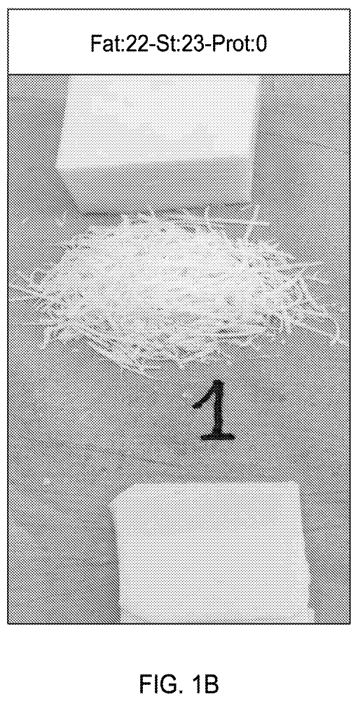

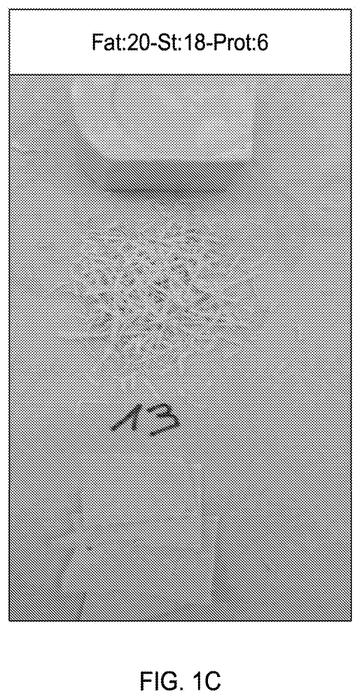

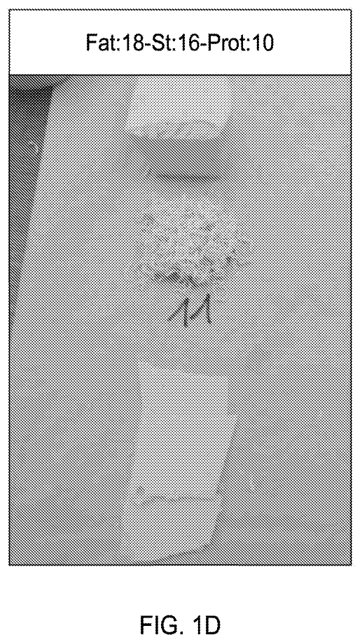

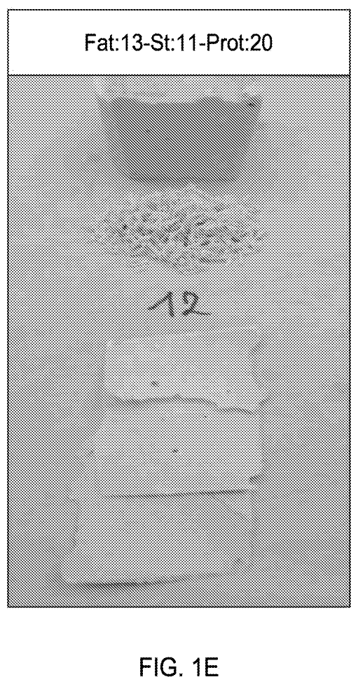

FIG. 1A illustrates a photograph of a commercial conventional vegan cheese that did not include CPI, and included beta-carotene to give a yellow color. FIG. 1B illustrates a photograph of a vegan cheese including no CPI (Sample 1). FIGS. 1C-E illustrates photographs of various vegan cheeses including CPI (Samples 13, 11, and 12, respectively). As the weight percentage of CPI was increased, the softness, stickiness, and darkness of the samples increased. Sample 13 (shown in FIG. 1C) was the preferred sample for processability (slicing and shredding). The flavor and color were acceptable up to 10 wt % CPI.

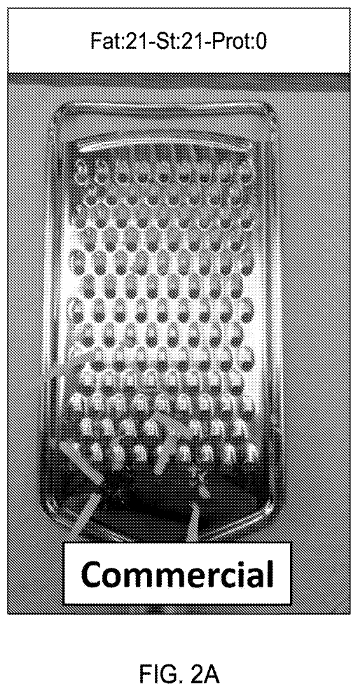

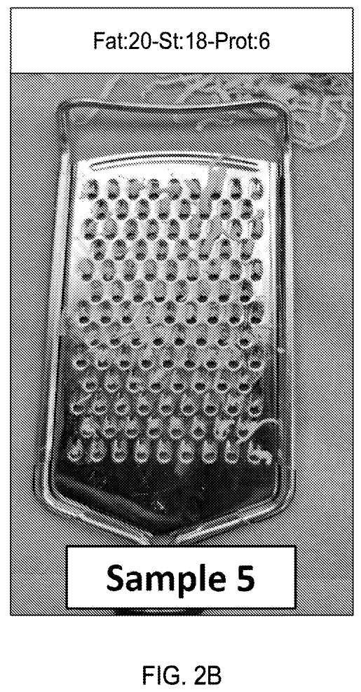

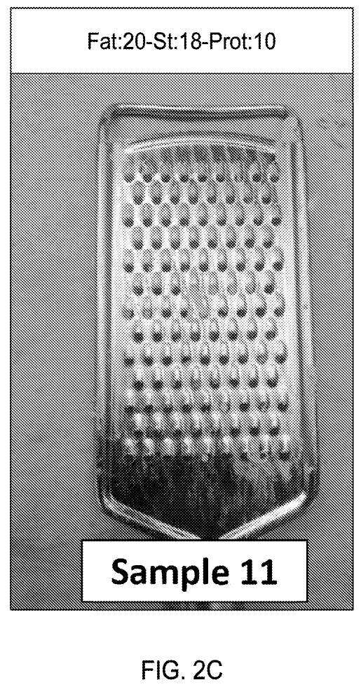

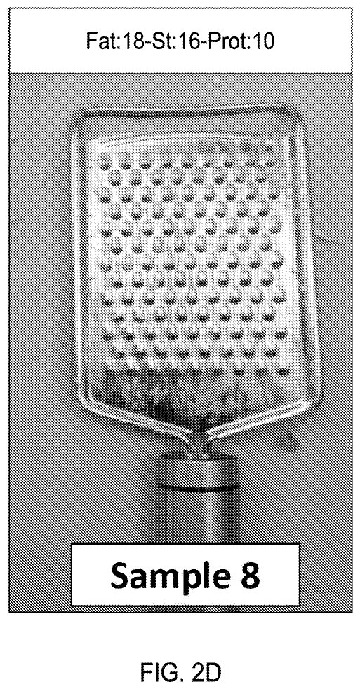

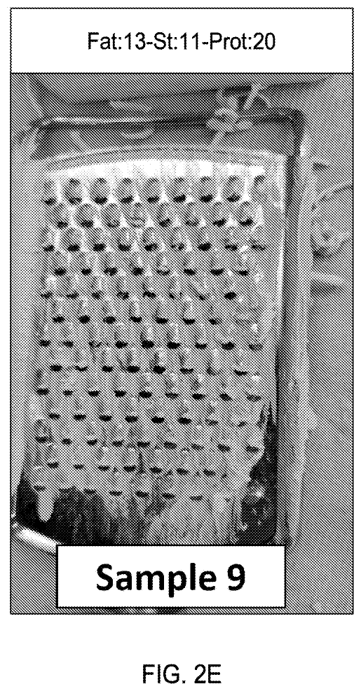

FIG. 2A illustrates a photograph of a grater after grating a commercial conventional vegan cheese that did not include CPI (the same cheese shown in FIG. 1A). FIGS. 2B-E illustrates photographs of a grater after grating various vegan cheeses including CPI (Samples 5, 11, 8, and 9, respectively). As the weight percentage of CPI was increased, the stickiness and amount of residue on the grater increased. At a similar weight percentage of CPI, an increased amount of starch decreased the amount of stickiness and residue (e.g., Samples 11 vs. 8).

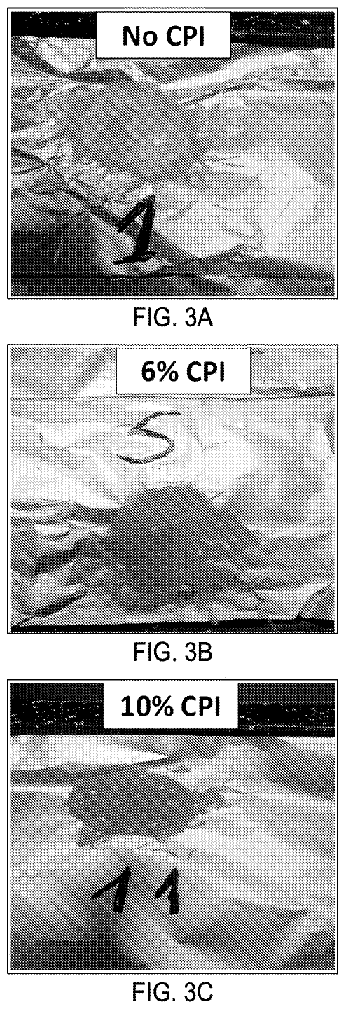

FIG. 3A illustrates a photograph of a vegan cheese including no CPI after toasting in an oven at 180° C. for 5 minutes (Sample 1). FIGS. 3B-C illustrate photographs of various vegan cheeses including CPI after toasting in an oven at 180° C. for 5 minutes (Samples 5 and 11, respectively). Addition of CPI resulted in browning after placing in the oven, likely due to occurrence of the Maillard reaction. This browning was also observed in commercial samples that contained protein (dairy cheese or vegan cheese that contained protein).

This Example shows that CPI can be used to produce a vegan cheese. The addition of the CPI improved nutrition by increasing the amount of protein in the cheese, improved the color after baking, reduced the brittleness of the cheese, and the cheese had a bland flavor that could easily be improved by flavor addition without need for masking agents.

### Example 3. Evaluation of CPI in Plant-Based Alternatives to Cheese (PBAC), and Comparison to PBAC Including Other Vegetable Proteins

Most commercial PBAC contain no protein. The main ingredients are fat, starch, hydrocolloids, salt. Many PBAC producers would like to add vegetable proteins into their products to improve nutrition, but the main limitations are addition of undesirable flavor and color. Addition of vegetable proteins may also negatively impact the texture of starch-based PBAC by interfering with the starch network. During production of PBAC, starch is gelatinized at elevated temperatures, followed by a sol-gel transition during cooling through entanglement, setback, and retrogradation of the starch molecules. A polysaccharide-based viscoelastic gel is formed entrapping water and oils.

The objective of this study was to evaluate corn protein isolate (CPI) as an ingredient in plant-based alternative to cheese (PBAC). The PBAC prototypes containing CPI were evaluated for their flavor, color, functionality and texture. Additionally, the performance of CPI in PBAC was compared to that of other vegetable proteins. Protein concentrates or isolates from the following botanical origins were evaluated: wheat, pea, lentil, rice, faba, soy, potato and oat. Two separate studies were completed: Study 1 was a comparison of a PBAC with no protein added to a PBAC with 6% CPI, and Study 2 was a comparison of an optimized PBAC with 6% protein from CPI with PBAC with 6% protein from wheat, pea, lentil, rice, faba, soy, potato or oat.

Production Process of PBAC: PBAC prototypes were produced in a Stephan cooker (UMM/SK5, Germany) with a double jacket system connected to a water bath (Julabo ED, Germany). The fat was heated in the Stephan cooker to 65° C. The dry ingredients were pre-mixed and added to the melted fat while stirring at 250 rpm. After fully incorporating the dry ingredients into the melted fat, water and citric acid were added while stirring at 250 rpm. Correction to the target pH was done in this stage. Then, under stirring at the same speed, the temperature was raised to 82° C. The prototype was cooked for 3 min at a temperature within the range of 80-85° C. The final step was to package the products while hot and place them into an ice water bath to cool them down. Once the product was at room temperature, the prototypes were labeled and stored in a controlled temperature fridge (5° C.) for 30 days. The CPI used was made as described herein at Example 1.

### Recipes for Studies 1 and 2.

Study 1 was a comparison of a PBAC with no protein added and a CPI-containing PBAC. Samples were coded as NO-protein and CPI, respectively. The recipes are shown in Table 2.

TABLE 2
Recipes of a PBAC with no protein
added and a CPI-containing PBAC.

| | NO-Protein | CPI |
|---|---|---|
| Fully refined coconut oil (%) | 20.0 | 18.0 |
| Lygomme ACH 864K (%) | 21.0 | 20.0 |
| Corn protein isolate (%) | 0.0 | 6.0 |
| Salt (%) | 1.5 | 1.5 |
| Total solids (%) | 42.5 | 45.5 |
| pH | 4.3 | 5.5 |
| Citric acid (50% solution) (g) | 2.7 | 2.7 |

For the CPI prototype, a higher amount of acid is needed to reach pH 4.5 than the NO-Protein prototype, which resulted in a sour product. For this reason, a pH 5.5 was selected.

Study 2 was a comparison of vegetable proteins from different sources. The recipe optimized to include 6% of protein from CPI was used as a base. The CPI was replaced by proteins from the following vegetable sources: wheat, pea, soy, lentil, potato, faba bean, rice, or oat. We used protein concentrates or isolates, so formulas were adjusted to obtain 6% protein content in the final formula, which resulted in recipes with varying total solids content (Table 3).

TABLE 3
Recipes of PBAC containing protein isolates or concentrates from different botanical origins to obtain a 6% protein level.

| | CPI | Wheat | Pea-RS | Pea-RE | Pea-870 | Pea-870H | Lentil | Rice | Faba | Soy | Potato 200 | Potato 300 | Oat |
|---|---|---|---|---|---|---|---|---|---|---|---|---|---|
| Corn Protein | 6.7 | — | — | — | — | — | — | — | — | — | — | — | — |
| Isolate (%) | | | | | | | | | | | | | |
| Hydrolysed | — | 7.8 | — | — | — | — | — | — | — | — | — | — | — |
| wheat protein | | | | | | | | | | | | | |
| (%) | | | | | | | | | | | | | |
| Pea Protein | — | — | 7.5 | — | — | — | — | — | — | — | — | — | — |
| Isolate - | | | | | | | | | | | | | |
| RadipureS | | | | | | | | | | | | | |
| (%) | | | | | | | | | | | | | |
| Hydrolysed | — | — | — | 7.5 | — | — | — | — | — | — | — | — | — |
| Pea Protein | | | | | | | | | | | | | |
| Isolate - | | | | | | | | | | | | | |
| RadipureE | | | | | | | | | | | | | |
| (%) | | | | | | | | | | | | | |
| Pea Protein | — | — | — | — | 7.5 | — | — | — | — | — | — | — | — |
| Isolate - | | | | | | | | | | | | | |
| Puris870 (%) | | | | | | | | | | | | | |
| Hydrolysed | — | — | — | — | — | 7.5 | — | — | — | — | — | — | — |
| Pea Protein | | | | | | | | | | | | | |
| Isolate - Puris | | | | | | | | | | | | | |
| 870H (%) | | | | | | | | | | | | | |
| Lentil Protein | — | — | — | — | — | — | 7.5 | — | — | — | — | — | — |
| Isolate (%) | | | | | | | | | | | | | |
| Rice Protein | — | — | — | — | — | — | — | 7.5 | — | — | — | — | — |
| Isolate (%) | | | | | | | | | | | | | |
| Faba bean | — | — | — | — | — | — | — | — | 9.2 | — | — | — | — |
| concentrate | | | | | | | | | | | | | |
| (%) | | | | | | | | | | | | | |
| Soy bean | — | — | — | — | — | — | — | — | — | 8.5 | — | — | — |
| concentrate | | | | | | | | | | | | | |
| (%) | | | | | | | | | | | | | |
| Potato | — | — | — | — | — | — | — | — | — | — | 6.7 | — | — |
| protein isolate - | | | | | | | | | | | | | |
| Solanic 200 | | | | | | | | | | | | | |
| (%) | | | | | | | | | | | | | |
| Potato | — | — | — | — | — | — | — | — | — | — | — | 6.7 | — |
| protein isolate - | | | | | | | | | | | | | |
| Solanic 300 | | | | | | | | | | | | | |
| (%) | | | | | | | | | | | | | |
| Oat protein | — | — | — | — | — | — | — | — | — | — | — | — | 10.7 |
| concentrate | | | | | | | | | | | | | |
| (%) | | | | | | | | | | | | | |
| Hydrogenated | 18.0 | 18.0 | 18.0 | 18.0 | 18.0 | 18.0 | 18.0 | 18.0 | 18.0 | 18.0 | 18.0 | 18.0 | 18.0 |
| coconut oil | | | | | | | | | | | | | |
| (%) | | | | | | | | | | | | | |
| Lygomme | 20.0 | 20.0 | 20.0 | 20.0 | 20.0 | 20.0 | 20.0 | 20.0 | 20.0 | 20.0 | 20.0 | 20.0 | 20.0 |
| ACH 864K | | | | | | | | | | | | | |
| (%) | | | | | | | | | | | | | |
| Salt (%) | 1.5 | 1.5 | 1.5 | 1.5 | 1.5 | 1.5 | 1.5 | 1.5 | 1.5 | 1.5 | 1.5 | 1.5 | 1.5 |
| Total solids | 46.2 | 47.3 | 47.0 | 47.0 | 47.0 | 47.0 | 47.0 | 47.0 | 48.7 | 48.0 | 46.2 | 46.2 | 50.2 |
| (%) | | | | | | | | | | | | | |
| Citric acid | 2.7 | 1.0 | 3.6 | 4.0 | 5.0 | 5.0 | 1.8 | 4.0 | 4.0 | 2.8 | 2.8 | — | 1.8 |
| (50% | | | | | | | | | | | | | |
| solution) (g) - | | | | | | | | | | | | | |
| pH 5.5 | | | | | | | | | | | | | |

### Sample Characterization Methods.

All samples were analyzed 7, 14, and 28 days after production by the methods detailed below. In most cases, we reported results obtained at 14 days as prototypes were stable by that time. For sensory evaluations and hardness determined by texture profile analysis (TPA) we reported results at 7, 14 and 28 days as we observed an evolution over the time evaluated.

Sensory Evaluation. Samples of PBAC cut into 3 cm³ cubes at ambient temperature were evaluated by panelists for their appearance, flavor, and texture properties. The panel consisted of 3 to 6 people from the Dairy Applications team.

Color of PBAC. The color value was measured using a Spectrophotometer CM-5 (Konika Minolta Sensing Europe B.V., Berlin, Germany). The measurement used a diameter of 30 cm of measuring area, and SCI/SCE—Excluded for reflectance as parameters. The color was expressed as Hunter CIELAB coordinates (L*, a*, b*). Three random readings were taken on 50 gr of freshly shredded prototype samples at room temperature.

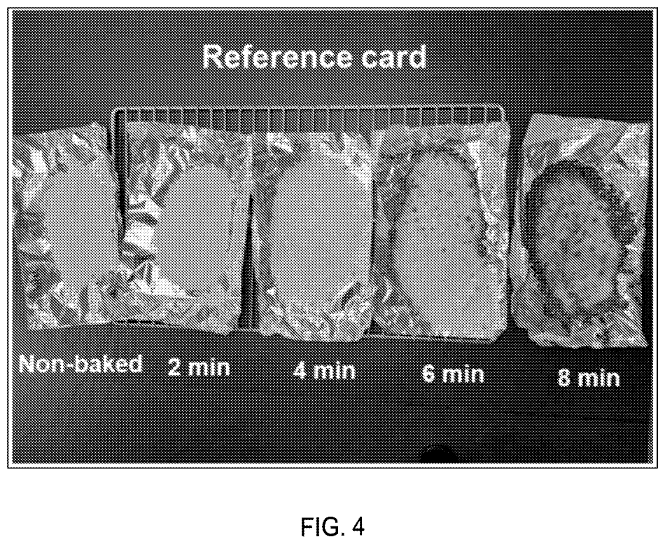

Color after baking of PBAC. Samples were prepared by placing 50 g of shredded PBAC on baking paper using a round mold of 11.5 cm diameter and baking it in the oven (Combi-Steamer Salvis CucinaEVO, The Netherlands) at 230° C. for 5 min. Results were compared to a reference card built for mozzarella cheese baked at 230° C. at different time periods (FIG. 4).

Additionally, once cold the PBAC was chopped to obtain a homogenized sample and its color was measured by a spectrophotometer as described above. Results obtained in this way were compared to those obtained for mozzarella at different baking times (Table 4).

TABLE 4
L*a*b* values of mozzarella cheese baked
during different periods of time.

| Time | L* | a* | b* |
|---|---|---|---|
| Not baked | 80.27 | 0.2 | 20.38 |
| 2 min at 230° C. | 77.16 | 0.31 | 22.47 |
| 4 min at 230° C. | 72.74 | 1.13 | 24.58 |
| 6 min at 230° C. | 60.55 | 4.22 | 25.07 |
| 8 min at 230° C. | 45.6 | 13.31 | 27.56 |

Processability. Processability was evaluated considering two aspects: stickiness while shredding and percentage of fines produced.

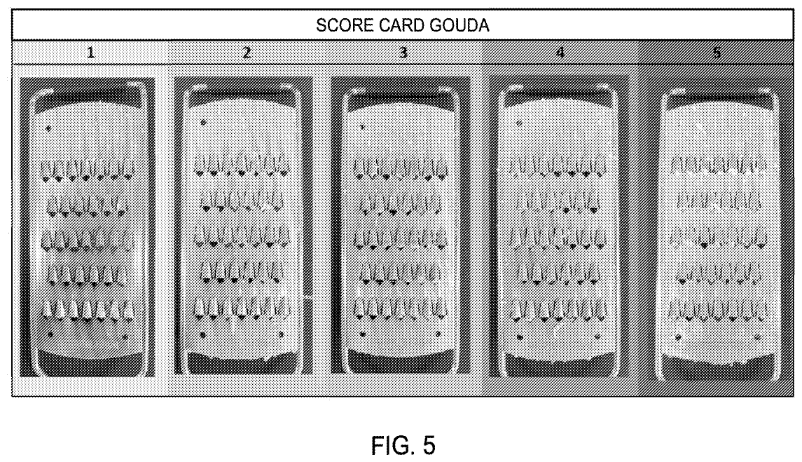

Stickiness while shredding. The residue on a grater surface after shredding 50 g of product was evaluated and rated according to the score card presented in FIG. 5. This scorecard went from 1 to 5 with 1 indicating the lowest amount of residue and 5 the highest.

Percentage of fines produced. A block of plant-based alternative to cheese prototype was shredded with a grater (Microplane gourmet julienne grater, USA) to obtain 50 g of sample prototype, then transferred to a 2 mm sieve for the test performance. The percentage of fines produced after shredding was calculated with the following formula:

$$Percentage of fines produced = 100 \% - ( \frac{100 \% * weight of cheese after sieving [ g ]}{weight of cheese before sieving [ g ]} )$$

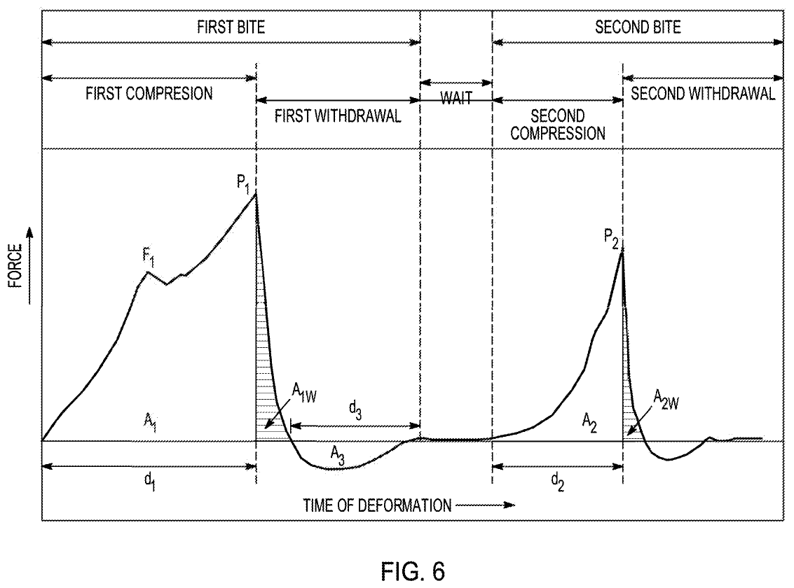

Texture profile analysis. Texture profile analysis was performed using a Texture Analyzer TA-XTplusC (Stable Micro Systems, Godalming, Surrey, UK). Samples were cut into cylinders with a height of 22 mm and a diameter of 20 mm and kept at 4° C. overnight to enable texture recovery. Cheese cylinders were compressed to 75% of the initial height in two subsequent compressions with a speed of 5 mm s⁻¹. Hardness, cohesiveness, and fracturability were measured in triplicate. FIG. 6 is a schematic of a typical curve obtained when doing a two-bite compression and the measurements used to calculate hardness, cohesiveness and fracturability. The definitions of hardness, cohesiveness and fracturability can be seen in Table 5. A1 and A2 are areas under the compression of the first-bite and second-bite curve, respectively. P1 and P2 are peaks of the first and second compressions, respectively. F1 is the first significant break in the first compression curve.

TABLE 5
Texture profile analysis (TPA) selected
texture terms and definitions.

| Term | Definition | How it is measured |
|---|---|---|
| Hardness | Force necessary to attain | Force corresponding |
| | a given deformation | to P1 |
| Fracturability | Force at significant break | Force corresponding |
| | in the curve on the first | to F1 |
| | bite (originally known as | |
| | “brittleness”) | |
| Cohesiveness | Strength of the internal | A2/A1 |
| | bonds making up the | |
| | body of the product | |

### Study 1 Results.

Comparison of a PBAC with no protein added and a CPI-containing PBAC. Samples were coded as NO-protein and CPI, respectively.

Sensory. Tables 6, 7 and 8 show the notes from the sensory evaluation at 7, 14 and 28 days, respectively.

The NO-Protein sample had a white color, typical vegan cheese texture and bland flavor, which is desirable as cheese flavors are added to most vegan cheeses. The texture of the NO-Protein sample became harder and crumblier over time.

The CPI sample had a light yellow color, was slightly crumbly and exhibited corn notes. The texture of the CPI sample became dryer and firmer over time, though firmness increased less than for the NO-Protein sample. Regarding flavor, the corn notes of the CPI samples were more pronounced at 28 days, but samples were still acceptable.

TABLE 6
Notes on appearance, texture and taste
from sensory evaluation at day 7.

| Code | Appearance | Texture | Taste | Acceptability |
|---|---|---|---|---|
| NO-Protein | White | Gummy, | Bland flavor | Acceptable |
| | | typical | | |
| | | texture | | |
| CPI | Light | Slightly | Corn notes, | Acceptable |
| | yellow | crumbly, | no acidity, | |
| | color | not pasty | pleasant but | |
| | | or sticky | not neutral | |
| | | to teeth | | |

TABLE 7
Notes on appearance, texture and taste
from sensory evaluation at day 14.

| Code | Appearance | Texture | Taste | Acceptability |
|---|---|---|---|---|
| NO-Protein | White | Dry, firm but | Bland | Acceptable |
| | | less brittle | flavor | |
| | | than CPI | | |
| CPI | Light yellow | Dry, firm, and | No corn | Acceptable |
| | color | brittle texture | taste | |

TABLE 8
Notes on appearance, texture and taste
from sensory evaluation at day 28.

| Code | Appearance | Texture | Taste | Acceptability |
|---|---|---|---|---|
| NO-Protein | White | Increased | Bland | Acceptable |
| | | firmness and | flavor | |
| | | brittleness | | |
| | | compared to | | |
| | | 14 days | | |
| CPI | Light yellow | More powdery | Slight | Acceptable |
| | color | and crumbly | corn | |
| | | than 14 days | flavor | |

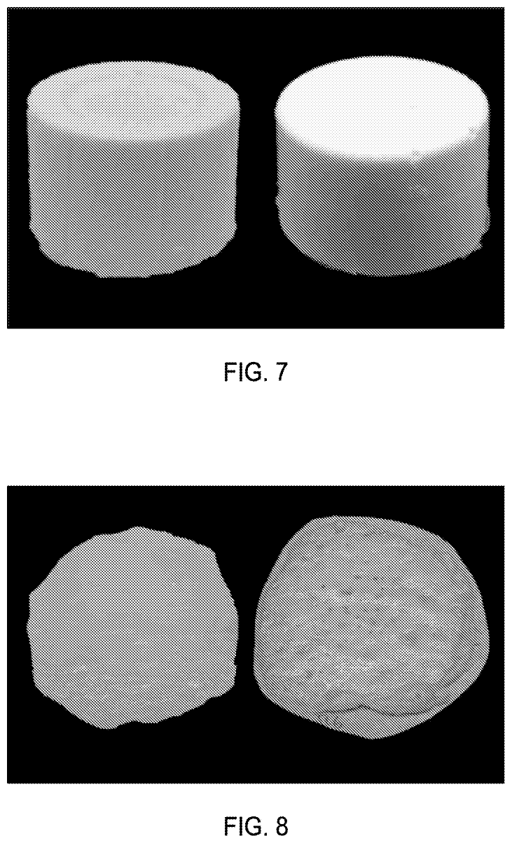

Color of PBAC. As shown in FIG. 7, NO-Protein prototypes (left) showed a white color while CPI prototypes (right) were light yellow.

L*a*b* values obtained for both prototypes at day 7 can be found in Table 9. No color development was observed during the testing period (up to 28 days).

TABLE 9
L*a*b* values for NO-Protein and CPI prototypes at day 7.

| Sample | L* | a* | b* |
|---|---|---|---|
| CPI | 74.59 | 2.25 | 23.18 |
| NO-Protein | 81.23 | −0.78 | 11.46 |

Color after baking of PBAC. As shown in FIG. 8, NO-Protein samples exhibit no browning after baking (left), while slight browning was observed at the edges of the CPI sample (right). However this browning is not as pronounced as the browning observed for mozzarella or other vegetable proteins.

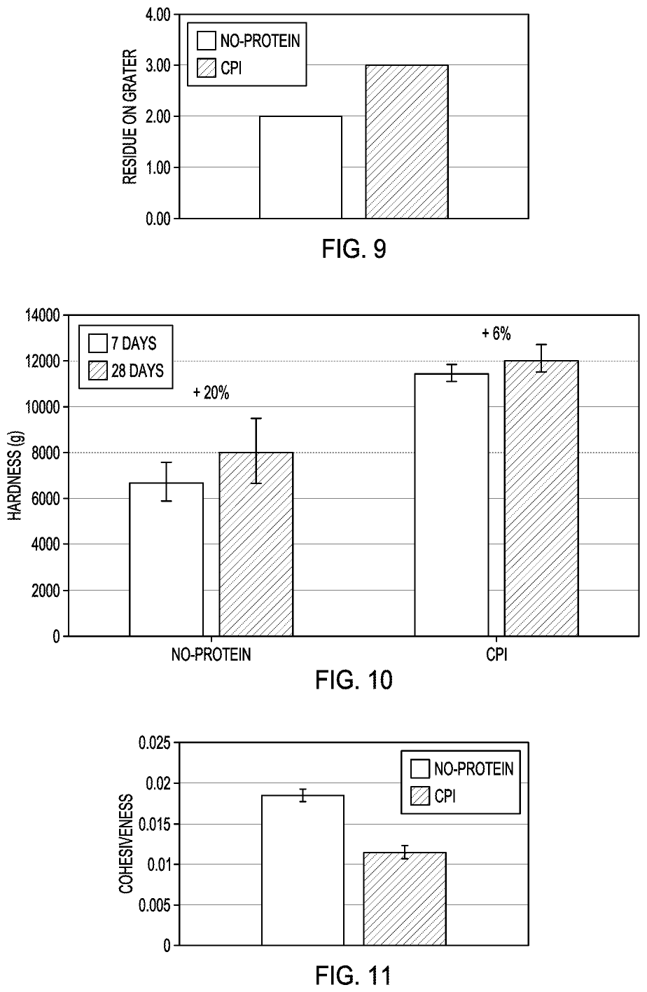

Processability—stickiness after shredding. NO-Protein samples were less sticky and left less residue on the surface of the grater than the CPI samples (FIG. 9) even though NO-Protein samples contained 3% more moisture than CPI samples. Higher moisture usually results in higher stickiness, so results presented in FIG. 9 suggests that the addition of CPI interferes with the starch-based structure resulting in a more pasty product that adheres more easily to the surface of the grater.

Processability—percentage of fines produced. NO-Protein samples produced lower level of fines compared to CPI samples, which was correlated with a higher fracturability (results not shown). However, due to the higher total solids values of the CPI samples it is difficult to conclude if these observations are due to the inclusion of CPI. A higher percentage of fines could also be due to lower moisture content (dryer samples).

Texture profile analysis. Hardness values of NO-Protein samples were lower than those of CPI samples, which could be explained by their lower total solids content. However, when we look at the development of hardness over time (FIG. 10) we observed that the hardness increase of NO-Protein samples was higher than the increase of the CPI samples (20 vs 6%). This could be because the presence of CPI may interfere with the retrogradation of the starch present in the formula, which could be responsible for the hardening of samples over time. Lower retrogradation could be desirable as it may result in a less crumbly texture of the PBAC over time.

Besides hardness we also looked at results of cohesiveness and fracturability. CPI samples were less cohesive than NO-Protein samples (FIG. 11). This correlates with a higher residue on grater of CPI samples and could also be explained by the weakening of the starch-based network when adding CPI.

In the case of fracturability, CPI samples exhibited higher fracturability values than NO-protein samples but it is difficult to determine whether these results are due to the higher total solids levels of the CPI samples which could make them more difficult to fracture.

### Study 2 Results.

Comparison of an optimized PBAC with 6% protein from CPI with PBAC with 6% protein from wheat, pea, lentil, rice, faba, soy, potato or oat.

Sensory. Tables 10, 11 and 12 show the sensory notes from the sensory evaluation at 7, 14 and 28 days, respectively.

We identified 3 groups of prototypes. Group 1 had acceptable PBAC due to color and flavor until day 28: CPI, wheat and lentil (though lentil was less preferred in terms of flavor compared to CPI and wheat). Group 2 had unacceptable PBAC due to flavor at day 28: Pea-870, Pea-870H, Rice, Soy, Potato 300. Group 3 had unacceptable PBAC due to color and flavor at day 28: Pea-RS, Pea-RE, Faba, Potato 200 and Oat. Rice and Potato 300 prototypes had acceptable flavor and color at day 7 or day 14, but became unacceptable at day 28 as some off-notes intensified over time.

TABLE 10
Sensory notes on appearance, texture, and taste from sensory evaluation at day 7.

| Code | Appearance | Texture | Taste | Acceptability |
|---|---|---|---|---|
| CPI | Light yellow | Slightly crumbly, | Corn notes, no | Acceptable |
| | color | not pasty or | acidity, pleasant | |
| | | sticky to teeth | but not neutral | |
| Wheat | White-greyish | A bit pasty, not | Strong flavor | Acceptable |
| | color | powdery, softer, | and odor (more | |
| | | and more cohesive | pronounced | |
| | | than CPI | than Corn). | |
| | | | Not acid flavor | |
| Pea-RS | Beige color | Powdery in mouth | Strong beany | Unacceptable due |
| | | and crumblier | and earthy notes | to color and flavor |
| | | than corn | | |
| Pea-RE | Light beige | Less crumbly and | Strong beany | Unacceptable due |
| | color | dry than Pea-RS | and earthy notes | to color and flavor |
| Pea-870 | Yellowish | Crumbly | Strong pea notes, | Unacceptable due |
| | color | (parmesan-like) | less earthy than | to flavor |
| | | | Pea-RS and Pea-RE | |
| Pea-870H | Lighter | Less crumbly | Medium-high | Unacceptable due |
| | yellow than | and a bit pastier | pea notes, | to flavor |
| | Pea-870 | than Pea-870 | slight bitterness | |
| Lentil | Whitish | Soft texture, | Lentil notes, | Acceptable |
| | opaque color | creamy, less | earthy but | |
| | | pasty than CPI | pleasant, creamy | |
| Rice | Light beige | Pasty, creamy, | Strong brothy | Acceptable |
| | color | a bit crumblier | notes, but still | |
| | | than Lentil | acceptable | |
| Faba | Brownish | Pasty, similar to | No flavor in the | Unacceptable due |
| | color | Corn | beginning but a | to color and flavor |
| | | | bitter aftertaste | |
| Soy | Light beige | Dry, crumbly | Beany notes | Unacceptable due |
| | color | | | to flavor |
| Potato 200 | Grey, purple | Pasty, not that | Strong unpleasant | Unacceptable due |
| | color | crumbly | flavor, earthy | to color and flavor |
| | | | difficult to describe | |
| Potato 300 | White color | A bit crumbly, | Very acid, but | Acceptable |
| | | pasty | still acceptable. | |
| | | | Less off notes | |
| | | | than Potato 200 | |
| Oat | Brown color | Very pasty and | Salty, strong | Unacceptable due |
| | | grainy | brothy notes | to color and flavor |

TABLE 11
Sensory notes on appearance, texture, and taste from sensory evaluation at day 14.

| Code | Appearance | Texture | Taste | Acceptability |
|---|---|---|---|---|
| CPI | Light yellow | Dry, firm, and | No corn taste | Acceptable |
| | color | brittle texture | | |
| Wheat | White-greyish | Soft texture, | Cereal taste | Acceptable |
| | color | less dry and | | |
| | | brittle than | | |
| | | 7 days. Elastic, | | |
| | | the closest to | | |
| | | cheese texture. | | |
| Pea-RS | Beige color | Dry texture | Strong pea | Unacceptable due |
| | | | off-flavor | to color and flavor |
| Pea-RE | Light beige | Soft texture | More bitter and | Unacceptable due |
| | color | | salty than Pea-RS. | to color and flavor |
| | | | Medium level | |
| | | | pea off-flavor. | |
| Pea-870 | Yellowish | Drier than | Medium level | Unacceptable due |
| | color | Pea-RE and | pea off-flavor | to flavor |
| | | brittle | | |
| Pea-870H | Yellowish | Less sandy | Slightly pea | Unacceptable |
| | color | than the other | off-flavor | due to flavor |
| | | pea prototypes | | |
| Lentil | Whitish | Soft texture, | Beany aftertaste | Acceptable |
| | opaque color | similar to wheat | but still | |
| | | | acceptable | |
| Rice | Beige color | Crumbly texture | Bitter, brothy | Unacceptable due |
| | | | notes intensified | to flavor |
| | | | over time and | |
| | | | long aftertaste. | |
| Faba | Brown color | Texture similar | Bitter flavor | Unacceptable due |
| | | to wheat | | to color and flavor |
| Soy | Light beige | Crumbly and | Beany off-notes | Unacceptable due |
| | color | dry texture like | | to flavor |
| | | parmesan cheese | | |
| Potato 200 | Grey-purple | Soft texture | Strong and | Unacceptable due |
| | color | | long-lasting | to color and flavor |
| | | | potato taste. Salty | |
| Potato 300 | White, neutral | Soft and | No potato | Acceptable |
| | color | cohesive texture | off-notes, | |
| | | | but acidic. | |
| Oat | Brown color | Less pasty than | Very salty | Unacceptable due |
| | | 7 days, texture | | to color and flavor |
| | | more similar to | | |
| | | dairy cheese | | |

TABLE 12
Sensory notes on appearance, texture, and taste from sensory evaluation at day 28.

| Code | Appearance | Texture | Taste | Acceptability |
|---|---|---|---|---|
| CPI | Light yellow | More powdery | Slight corn flavor | Acceptable |
| | color | and crumbly | | |
| | | than 14 days | | |
| Wheat | White-greyish | Nice and soft | Slight wheat | Acceptable |
| | color | texture | flavor | |
| Pea-RS | Beige color | Very dry and | Very intense pea | Unacceptable due |
| | | powdery texture | and earthy off-notes, | to color and flavor |
| | | | salty taste | |
| Pea-RE | Light beige | Dry and powdery | Similar flavor | Unacceptable due |
| | color | texture | profile to Pea-RS, | to color and flavor |
| | | | but less intense | |
| Pea-870 | Yellowish | Powdery texture, | Strong pea flavor | Unacceptable due |
| | color | but less than | but less intense | to flavor |
| | | Pea-RS and | than in Pea-RS | |
| | | Pea-RE | andPea-RE | |
| Pea-870H | Yellowish | Soft and creamy | Mild pea flavor, | Unacceptable due |
| | color | texture | less intense than | to flavor |
| | | | Pea-RS, Pea-RE | |
| | | | and Pea-870 | |
| Lentil | Whitish | Soft but | Mild flavor, | Acceptable |
| | opaque color | powdery texture | slightly acidic. | |
| | | | Still acceptable | |
| | | | but less preferred | |
| | | | compared to | |
| | | | CPI and wheat | |
| Rice | Beige color | Crumbly texture | Intensive taste, | Unacceptable due |
| | | | not pleasant. | to flavor |
| | | | Getting worse | |
| | | | with time. | |
| Faba | Brown color | Soft texture | Strong, long-lasting | Unacceptable due |
| | | | aftertaste | to color and flavor |
| Soy | Light beige | Very powdery | Strong beany taste | Unacceptable due |
| | color | and dry texture | | to flavor |
| Potato 200 | Grey-purple | Soft texture | Strong potato | Unacceptable due |
| | color | | taste, long-lasting | to color and flavor |
| | | | and salty. | |
| Potato 300 | Nice white | Soft and cohesive | Slightly potato | Unacceptable due |
| | color | texture | flavor, but | to flavor |
| | | | very acidic. | |
| Oat | Brown color | Soft texture | Salty, bullion | Unacceptable due |
| | | | taste. | to color and flavor |

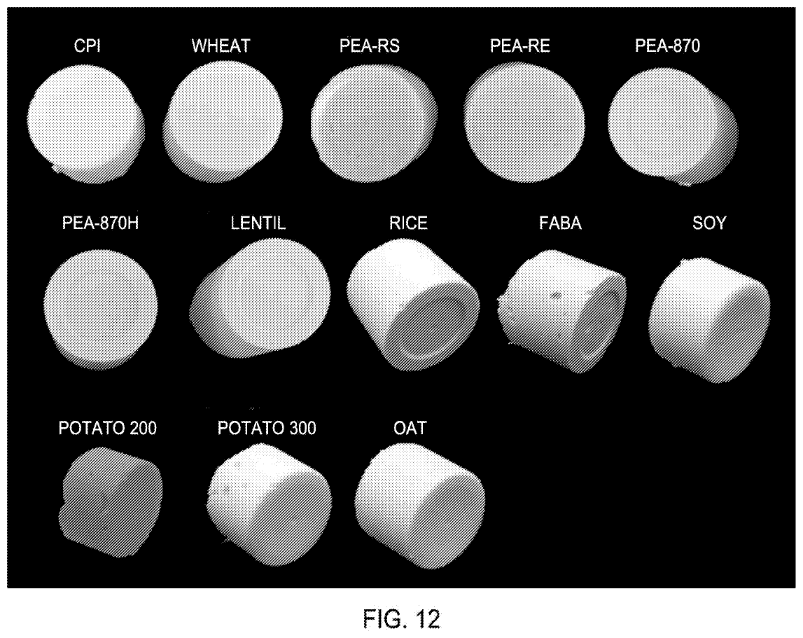

Color. The color of the different PBAC are shown in FIG. 12. As mentioned above, the following prototypes had unacceptable color: Pea-RS, Pea-RE, Faba, Potato 200, Oat.

Table 13 shows the L*a*b* values obtained for the different PBAC. Higher L* and lower a* values are preferred. Higher b* values are acceptable. There were no or minor changes of these values over time (results at 14 or 28 days not shown).

TABLE 13
L*a*b* values for different PBAC with proteins
from different vegetable sources at day 7.

| Sample | L* | a* | b* |
|---|---|---|---|
| CPI | 74.59 | 2.25 | 23.18 |
| Wheat | 70.86 | 1.76 | 16.89 |
| Pea-RS | 69 | 3.73 | 18.08 |
| Pea-RE | 68.97 | 3.23 | 17.28 |
| Pea-870 | 75.37 | 2.89 | 25.62 |
| Pea-870H | 76.38 | 2.47 | 26.37 |
| Lentil | 77.25 | 0.57 | 16.67 |
| Rice | 73.16 | 2.52 | 16.69 |
| Faba | 65.32 | 4.34 | 18.23 |
| Soy | 75.5 | 2.65 | 19.79 |
| Potato 200 | 66.4 | 1.98 | 8.35 |
| Potato 300 | 80.59 | −0.24 | 11.41 |
| Oat | 54.83 | 5.18 | 18.755 |
| NO-Protein | 81.23 | −0.78 | 11.46 |

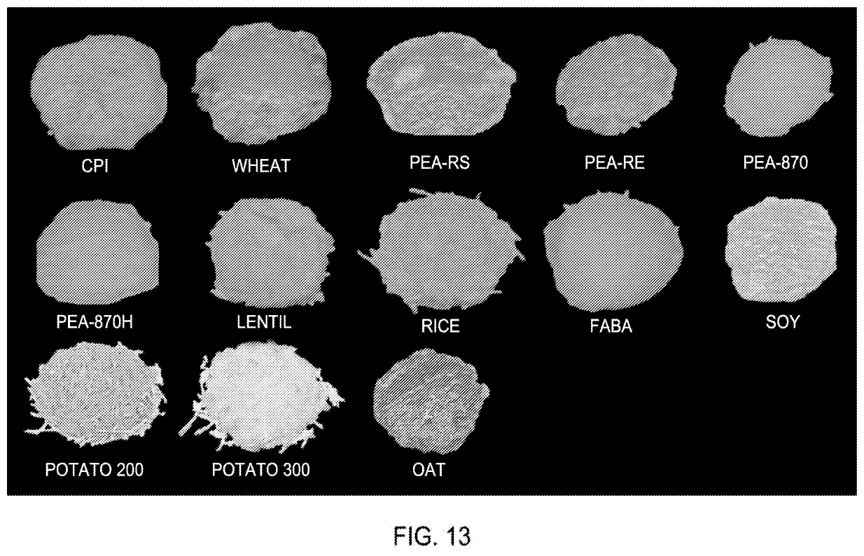

Color after baking of PBAC. L*a*b* values of prototypes after baking changed for all prototypes (with L* values being lower after baking). However, this browning was not similar to what we see in pizza cheese. Except for wheat, potato 300 and to some extent rice (FIG. 13).

More investigation is needed to understand the components of these isolates to understand the reason of the unique color developement and try to mimic it.

Processability and Texture Profile Analysis. There was some variability among prototypes regarding their processability (grater score and % fines) and texture determined by TPA, which is an indication that each vegetable protein affects the structure of the cheese in its own way (results not shown). Once a vegetable protein is identified as suitable for PBAC based on flavor and color, optimization of the recipe to obtain the right texture and processability should be done.

### Conclusions.

Compared to PBAC with no protein, adding CPI to PBAC improved nutrition, improved browning when baked, and reduced hardening over time. Compared to PBAC with proteins from non-CPI sources, PBAC including CPI had a blander flavor than pea, lentil, rice, faba, soy, potato, and oat. Compared to PBAC with proteins from non-CPI sources, PBAC including CPI improved color and flavor compared to certain potato and pea sources, faba, and oat. Compared to PBAC with proteins from non-CPI sources, PBAC including CPI had no allergen compared to soy and wheat.

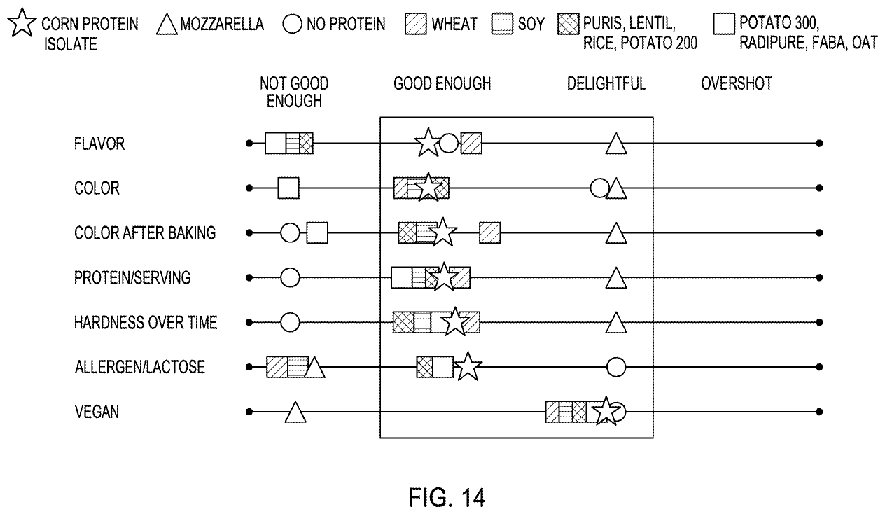

FIG. 14 illustrates a performance map of CPI-containing PBAC compared to mozzarella, PBAC with no protein, and PBAC with other vegetable proteins.

No studies were conducted to compare PBAC to dairy cheese. However, a CPI-containing PBAC has at least the following advantages compared to dairy cheese: vegan, no allergen compared to milk proteins, and suitable for lactose intolerants.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects.

The following exemplary Aspects are provided, the numbering of which is not to be construed as designating levels of importance:

Aspect 1 provides a cheese analogue product comprising:
a corn protein isolate (CPI) that is ≥0 wt % to ≤20 wt % of the cheese analogue product; wherein
   at least about 85 wt % of the CPI on a dry basis is corn protein, and
   the CPI comprises an “a*” color value ranging from about −2.5 to about 1.5, and a “b*” color value ranging from about 5 to about 25.

Aspect 2 provides the cheese analogue product of Aspect 1, wherein the cheese analogue product is substantially free of protein and fat from animal sources.

Aspect 3 provides the cheese analogue product of any one of Aspects 1-2, wherein less than 1 wt % of the cheese analogue product is one or more materials derived from animal sources.

Aspect 4 provides the cheese analogue product of any one of Aspects 1-3, wherein the cheese analogue product is substantially free of protein and fat from dairy sources.

Aspect 5 provides the cheese analogue product of any one of Aspects 1-4, wherein less than 1 wt % of the cheese analogue product is one or more materials derived from dairy sources.

Aspect 6 provides the cheese analogue product of any one of Aspects 1-5, wherein the cheese analogue product is a vegan cheese.

Aspect 7 provides the cheese analogue product of any one of Aspects 1-6, wherein the cheese analogue product is a block vegan cheese.

Aspect 8 provides the cheese analogue product of any one of Aspects 1-7, wherein the CPI is ≥1 wt % to ≤10 wt % of the cheese analogue product.

Aspect 9 provides the cheese analogue product of any one of Aspects 1-8, wherein the CPI is ≥3 wt % to ≤9 wt % of the cheese analogue product.

Aspect 10 provides the cheese analogue product of any one of Aspects 1-9, wherein the CPI is ≥5 wt % to ≤7 wt % of the cheese analogue product.

Aspect 11 provides the cheese analogue product of any one of Aspects 1-10, wherein the cheese analogue comprises one or more fats, wherein a weight ratio of the one or more fats to the CPI is 1:1 to 4:1.

Aspect 12 provides the cheese analogue product of any one of Aspects 1-11, wherein the cheese analogue comprises one or more fats, wherein a weight ratio of the one or more fats to the CPI is 1.5:1 to 3.5:1.

Aspect 13 provides the cheese analogue product of any one of Aspects 1-12, wherein the cheese analogue comprises one or more fats, wherein a weight ratio of the one or more fats to the CPI is 3.1:1 to 3.5:1.

Aspect 14 provides the cheese analogue product of any one of Aspects 1-13, wherein the cheese analogue comprises one or more starch components, wherein a weight ratio of the one or more starch components to the CPI is 1:1 to 4:1.

Aspect 15 provides the cheese analogue product of any one of Aspects 1-14, wherein the cheese analogue comprises one or more starch components, wherein a weight ratio of the one or more starch components to the CPI is 1.3:1 to 3.2:1.

Aspect 16 provides the cheese analogue product of any one of Aspects 1-15, wherein the cheese analogue comprises one or more starch components, wherein a weight ratio of the one or more starch components to the CPI is 2.5:1 to 3.5:1.

Aspect 17 provides the cheese analogue product of any one of Aspects 1-16, wherein the CPI is less than about 1.5 wt % oil on a dry basis.

Aspect 18 provides the cheese analogue product of any one of Aspects 1-17, wherein the CPI is less than about 1 wt % oil on a dry basis, or less than about 0.5 wt % oil on a dry basis.

Aspect 19 provides the cheese analogue product of any one of Aspects 1-18, wherein the corn protein is about 87 wt % to about 98 wt % of the CPI on a dry basis, or about 87 wt % to about 92 wt % of the CPI on a dry basis.

Aspect 20 provides the cheese analogue product of any one of Aspects 1-19, wherein the CPI has an L* color value of at least 88.

Aspect 21 provides the cheese analogue product of any one of Aspects 1-20, wherein the CPI has an L* color value of about 88 to about 95 or from about 90 to about 92.

Aspect 22 provides the cheese analogue product of any one of Aspects 1-21, wherein the “a*” color value of the CPI ranges from about −2 to about 1.5, or from about −2 to about −1, or about −0.5 to about 1.5, or about −0.3 to about 0.3, or from about −0.2 to about 0.2.

Aspect 23 provides the cheese analogue product of any one of Aspects 1-22, wherein the “b*” color value of the CPI ranges from about 1.0 to about 20, or from about 10 to about 15.

Aspect 24 provides the cheese analogue product of any one of Aspects 1-23, wherein the CPI has a soluble carbohydrate concentration of 40 g/kg or less, or 25 g/kg or less.

Aspect 25 provides the cheese analogue product of any one of Aspects 1-24, wherein the CPI has an organic acid concentration of about 4.25 g/kg or less, 3.5 g/kg or less, or 2.0 g/kg or less.

Aspect 26 provides the cheese analogue product of any one of Aspects 1-25, wherein the CPI has an aflatoxin concentration of less than about 1 ppb, or less than about 0.5 ppb.

Aspect 27 provides the cheese analogue product of any one of Aspects 1-26, wherein the CPI has a free sulfite concentration of less than about 150 ppm, less than about 120 ppm, or less than about 100 ppm.

Aspect 28 provides the cheese analogue product of any one of Aspects 1-27, wherein the CPI is made using a method comprising:
providing a destarched corn gluten material; and
washing the destarched corn gluten material with a solvent comprising water and a water-miscible organic solvent to obtain the CPI.

Aspect 29 provides the cheese analogue product of Aspect 28, wherein the destarched corn gluten material comprises residual insoluble starch solids ranging from about 0.1 to about 3.0 wt % on a dry basis, as measured by Ewers' Polarimetric method ISO 10520:1997.

Aspect 30 provides the cheese analogue product of any one of Aspects 28-29, wherein the water-miscible organic solvent comprises ethanol, isopropanol, or mixtures thereof, in a concentration ranging from about 75 wt % to about 100 wt %.

Aspect 31 provides the cheese analogue product of any one of Aspects 28-30, wherein the water-miscible organic solvent is in a concentration ranging from about 85 wt % to about 100 wt %, from about 75 wt % to about 95 wt %, or from about 85 wt % to about 95 wt %.

Aspect 32 provides the cheese analogue product of any one of Aspects 28-31, wherein the volume of the water-miscible organic solvent is from about 3 to about 40 liters per kilogram of destarched corn gluten having a moisture content of up to 65 wt %.

Aspect 33 provides the cheese analogue product of any one of Aspects 1-32, wherein the CPI is made using a method comprising:
providing a corn gluten material comprising at least about 65 wt % protein;
destarching the corn gluten material; and
washing the destarched corn gluten material with a solvent comprising about 75 wt % to about 100 wt % ethanol or isopropanol to remove non-protein components, to obtain the CPI.

Aspect 34 provides the cheese analogue product of Aspect 33, wherein the non-protein components include organic acids, carbohydrates, mycotoxins, and oils.

Aspect 35 provides the cheese analogue product of any one of Aspects 1-34, wherein the CPI is made using a method comprising:
providing a destarched corn gluten material; and
washing the destarched corn gluten material with a solvent comprising water and a water-miscible organic solvent to obtain the CPI, wherein a total of from about 3 L to about 40 L of solvent per kilogram of destarched corn gluten material is used during the washing step.

Aspect 36 provides the cheese analogue product of Aspect 35, wherein the solvent is chosen from ethanol, ethyl acetate, isopropanol, and mixtures thereof.

Aspect 37 provides the cheese analogue product of any one of Aspects 1-36, wherein the cheese analogue product comprises one or more fats.

Aspect 38 provides the cheese analogue product of Aspect 37, wherein the one or more fats are 1 wt % to 35 wt % of the cheese analogue product.

Aspect 39 provides the cheese analogue product of any one of Aspects 37-38, wherein the one or more fats are 5 wt % to 25 wt % of the cheese analogue product.

Aspect 40 provides the cheese analogue product of any one of Aspects 37-39, wherein the one or more fats are 15 wt % to 25 wt % of the cheese analogue product.

Aspect 41 provides the cheese analogue product of any one of Aspects 37-40, wherein the one or more fats comprise an animal-based oil, a plant-based oil, or a combination thereof.

Aspect 42 provides the cheese analogue product of any one of Aspects 37-41, wherein the one or more fats comprise coconut oil, corn oil, canola oil, cottonseed oil, olive oil, palm oil, peanut oil, rapeseed oil, safflower oil, sesame oil, soybean oil, sunflower oil, cocoa butter, shea butter, mango butter, a fraction thereof, a middle or high oleic version thereof, a hydrogenated oil formed therefrom, an interesterified oil formed therefrom, or a combination thereof.

Aspect 43 provides the cheese analogue product of any one of Aspects 37-42, wherein the one or more fats comprise hydrogenated coconut fat.

Aspect 44 provides the cheese analogue product of any one of Aspects 1-43, wherein the cheese analogue product comprises one or more starch components.

Aspect 45 provides the cheese analogue product of Aspect 44, wherein the one or more starch components are 1 wt % to 40 wt % of the cheese analogue product.

Aspect 46 provides the cheese analogue product of any one of Aspects 44-45, wherein the one or more starch components are 5 wt % to 25 wt % of the cheese analogue product.

Aspect 47 provides the cheese analogue product of any one of Aspects 44-46, wherein the one or more starch components are 15 wt % to 25 wt % of the cheese analogue product.

Aspect 48 provides the cheese analogue product of any one of Aspects 44-47, wherein the cheese analogue product comprises one or more fats, wherein a weight ratio of the one or more fats to the one or more starch components is 0.5:1 to 2:1.

Aspect 49 provides the cheese analogue product of any one of Aspects 44-48, wherein the cheese analogue product comprises one or more fats, wherein a weight ratio of the one or more fats to the one or more starch components is 1:1 to 1.2:1.

Aspect 50 provides the cheese analogue product of any one of Aspects 44-49, wherein the one or more starch components comprise one or more starches, natural starches, modified starches, or a combination thereof.

Aspect 51 provides the cheese analogue product of Aspect 50, wherein the one or more starches and/or modified starches are 50 wt % to 100 wt % of the one or more starch components.

Aspect 52 provides the cheese analogue product of any one of Aspects 50-51, wherein the one or more starches and/or modified starches are derived from corn, pea, potato, sweet potato, banana, barley, wheat, rice, sago, amaranth, tapioca, arrowroot, canna, sorghum, buckwheat, barley, cassava, kudzu, oca, sago, taro, yam, bean, waxy or high amylose varieties thereof, or a combination thereof.

Aspect 53 provides the cheese analogue product of any one of Aspects 44-52, wherein the one or more starch components comprise guar, carrageenan, or a combination thereof.

Aspect 54 provides the cheese analogue product of any one of Aspects 44-53, wherein the one or more starch components comprise guar and carrageenan.

Aspect 55 provides the cheese analogue product of any one of Aspects 1-54, wherein the cheese analogue product is substantially free of added colorants.

Aspect 56 provides the cheese analogue product of any one of Aspects 1-55, wherein added colorants are less than 0.1 wt % of the cheese analogue product.

Aspect 57 provides the cheese analogue product of any one of Aspects 1-56, wherein the cheese analogue product comprises one or more colorants.

Aspect 58 provides the cheese analogue product of any one of Aspects 1-57, wherein the cheese analogue product comprises beta-carotene.

Aspect 59 provides the cheese analogue product of any one of Aspects 1-58, wherein the cheese analogue product comprises a salt that is NaCl.

Aspect 60 provides the cheese analogue product of Aspect 59, wherein the salt is 0 wt % to 5 wt % of the cheese analogue product.

Aspect 61 provides the cheese analogue product of any one of Aspects 59-60, wherein the salt is 0.1 wt % to 3 wt % of the cheese analogue product.

Aspect 62 provides the cheese analogue product of any one of Aspects 1-61, wherein the cheese analogue product comprises water.

Aspect 63 provides the cheese analogue product of Aspect 62, wherein water is 30 wt % to 70 wt % of the cheese analogue product.

Aspect 64 provides the cheese analogue product of any one of Aspects 62-63, wherein water is 40 wt % to 60 wt % of the cheese analogue product.

Aspect 65 provides the cheese analogue product of any one of Aspects 62-64, wherein water is 53 wt % to 58 wt % of the cheese analogue product.

Aspect 66 provides the cheese analogue product of any one of Aspects 1-65, wherein the cheese analogue product comprises one or more additives comprising fiber, yeast, stabilizer, emulsifier, flavor, spices, flavor-masking agent, preservative, nutritional additive, texture-modification additive, acidifier, or a combination thereof.

Aspect 67 provides a vegan cheese product comprising:
a corn protein isolate (CPI) that is >0.1 wt % and <20 wt % of the vegan cheese product;
one or more fats that are 5 wt % to 25 wt % of the vegan cheese product;
one or more starch components that are 5 wt % to 25 wt % of the vegan cheese product; and
water that is 40 wt % to 60 wt % of the vegan cheese product;
wherein
   at least about 85 wt % of the CPI on a dry basis is corn protein, and
   the CPI comprises an “a*” color value ranging from about −2.5 to about 1.5, and a “b*” color value ranging from about 5 to about 25.

Aspect 68 provides a method of making the cheese analogue product of any one of Aspects 1-67, the method comprising:
heating a mixture of hydrated CPI and oil to form the cheese analogue product of any one of Aspects 1-67.

Aspect 69 provides the method of Aspect 68, further comprising cooling the mixture.

Aspect 70 provides the method of any one of Aspects 68-69, wherein the heating of the mixture comprises maintaining the mixture at 50° C. to 95° C. for at least about 1 minute.

Aspect 71 provides the method of any one of Aspects 68-70, wherein the heating of the mixture comprises maintaining the mixture at 75° to 90° C. for 2 minutes to 5 minutes.

Aspect 72 provides the method of any one of Aspects 68-71, further comprising combining the hydrated CPI and the oil.

Aspect 73 provides the method of any one of Aspects 68-72, further comprising hydrating the CPI.

Aspect 74 provides the method of Aspect 73, wherein hydrating the CPI comprises combining the CPI with water.

Aspect 75 provides the method of any one of Aspects 68-74, wherein the oil further comprises one or more starch components.

Aspect 76 provides the method of Aspect 75, further comprising combining the one or more starch components with the oil prior to forming the mixture of the hydrated CPI and the oil.

Aspect 77 provides the method of Aspect 76, further comprising heating the mixture of the hydrated CPI and oil to about 50° C. to about 95° C. prior to forming the mixture of the hydrated CPI and the oil.

Aspect 78 provides the method of any one of Aspects 76-77, further comprising heating the mixture of the hydrated CPI and oil to about 60° C. to about 70° C. prior to forming the mixture of the hydrated CPI and the oil.

Aspect 79 provides a method of making the cheese analogue product of any one of Aspects 1-67, the method comprising:
combining the CPI with water to hydrate the CPI;
combining dry ingredients with an oil;
combining the hydrated CPI and the oil that comprises the dry ingredients to form a mixture; and
heating the mixture of hydrated CPI and oil to 50° C. to 95° C. for at least about 1 minute, to form the cheese analogue product.

1. A cheese analogue product comprising:
a corn protein isolate (CPI) that is ≥0.1 wt % to ≤20 wt % of the cheese analogue product;
wherein
at least about 85 wt % of the CPI on a dry basis is corn protein, and
the CPI comprises an “a*” color value ranging from about −2.5 to about 1.5, and a “b*” color value ranging from about 5 to about 25.

2. The cheese analogue product of claim 1, wherein less than 1 wt % of the cheese analogue product is one or more materials derived from animal sources.

3. The cheese analogue product of claim 1, wherein the cheese analogue product is a vegan cheese.

4. The cheese analogue product of claim 1, wherein the CPI is ≥1 wt % to ≤10 wt % of the cheese analogue product.

5. The cheese analogue product of claim 1, wherein the cheese analogue product comprises one or more fats, wherein a weight ratio of the one or more fats to the CPI is 1:1 to 4:1.

6. The cheese analogue product of claim 1, wherein the CPI is less than about 1.5 wt % oil on a dry basis.

7. The cheese analogue product of claim 1, wherein the corn protein is about 87 wt % to about 98 wt % of the CPI on a dry basis.

8. The cheese analogue product of claim 1, wherein the CPI has an L* color value of about 88 to about 95.

9. The cheese analogue product of claim 1, wherein the “a*” color value of the CPI ranges from about −2 to about 1.5.

10. The cheese analogue product of claim 1, wherein the “b*” color value of the CPI ranges from about 1.0 to about 20.

11. The cheese analogue product of claim 1, wherein the CPI is made using a method comprising:
destarching a corn gluten material that comprises at least about 65 wt % protein; and
washing the destarched corn gluten material with a solvent comprising about 75 wt % to about 100 wt % ethanol or isopropanol to remove non-protein components, to obtain the CPI.

12. The cheese analogue product of claim 1, wherein the cheese analogue product comprises one or more fats that are 1 wt % to 35 wt % of the cheese analogue product.

13. The cheese analogue product of claim 1, wherein the cheese analogue product comprises one or more fats and the one or more fats comprise hydrogenated coconut fat.

14. The cheese analogue product of claim 1, wherein the cheese analogue product comprises one or more starch components that are 1 wt % to 40 wt % of the cheese analogue product and that comprise one or more natural starches, modified starches, or a combination thereof.

15. The cheese analogue product of claim 14, wherein the cheese analogue product comprises one or more fats, wherein a weight ratio of the one or more fats to the one or more starch components is 0.5:1 to 2:1.

16. The cheese analogue product of claim 14, wherein a weight ratio of the one or more starch components to the CPI is 1:1 to 4:1.

17. The cheese analogue product of claim 14, wherein the one or more starch components comprise guar, carrageenan, or a combination thereof.

18. The cheese analogue product of claim 1, wherein the cheese analogue product comprises salt, food coloring, water, fiber, yeast, stabilizer, emulsifier, flavor, spice, flavor-masking agent, preservative, nutritional additive, texture-modification additive, acidifier, or a combination thereof.

19. A vegan cheese product comprising:
a corn protein isolate (CPI) that is ≥0.1 wt % and ≤20 wt % of the vegan cheese product;
one or more fats that are 5 wt % to 25 wt % of the vegan cheese product;
one or more starch components that are 5 wt % to 25 wt % of the vegan cheese product; and
water that is 40 wt % to 60 wt % of the vegan cheese product;
wherein
at least about 85 wt % of the CPI on a dry basis is corn protein, and
the CPI comprises an “a*” color value ranging from about −2.5 to about 1.5, and a “b*” color value ranging from about 5 to about 25.

20. A method of making a cheese analogue product, the method comprising:
heating a mixture of hydrated corn protein isolate (CPI) and oil to form the cheese analogue product;
wherein
at least about 85 wt % of the CPI on a dry basis is corn protein, and
the CPI comprises an “a*” color value ranging from about −2.5 to about 1.5, and a “b*” color value ranging from about 5 to about 25.
